(19) United States
(12) Patent Application Publication
(10) Pub. No.: US 2014/0233219 A1
(43) Pub. Date: Aug. 21, 2014

(54) Love Glow Key

(71) Applicant: Bernadette Taylor, Largo, MD (US)

(72) Inventor: Bernadette Taylor, Largo, MD (US)

(21) Appl. No.: 13/769,234

(22) Filed: Feb. 15, 2013

(51) Int. Cl. F21V 33/00; F21V 31/04

(52) U.S. Cl. CPC F21V 33/0004; F21V 31/04
USPC 362/101; 362/109; 362/116

(57) ABSTRACT

This invention relates to a key that will illuminate in the dark. Why is it needed? The concept serves as a niche for the market and has the potential for making keys. It's easily recognizable simply by associating the key color with homes, locks, garages, offices, machinery and ect. This also includes anything that requires identification of a select key when light may not be available. Who benefits? Adults and children who need to gain access to secure homes at night. The key will reduce fumbling to identify keys during late evenings and nights. Disabled people will benefit because the key will help them maneuver through things during the night quickly. Being able to quickly access a locked vehicle at night will also benefit people. Shut down or disabled machinery could potentially reduce the number of physical attacks on victims, robberies, muggings, murders and ect.

### FIELD OF THE INVENTION

This invention relates to items that are able to illuminate in the dark. More specifically this item is key, a key which will feature a plastic piece to be added on which illuminates in the dark.

### BACKGROUND OF THE INVENTION

With the amount of crime going on in the world, we must find other ways to try to prevent the activities from occurring. For example, when it's dark it's often difficult to see. There specific key will be color coded and easier for them to identify at night. Love Glow will be able to open a variety of locks, not just doors.

For example; In the case of a woman carrying bags into the house at night or an elderly person trying to distinguish between other keys, Love Glows would make this process easier. This will prevent rummaging through items to locate there keys. As stated earlier the world is filled with crime and Love Glows has the ability to prevent certain activities from occurring. There have been times when people have tried to get inside of their houses and because they were unable to locate there keys fast enough, they were victims of robberies or assaults.

A person may feel that identifying keys and preventing thefts and robberies can be done in other ways. Ways including locating the key before exiting the car, having street lights, porch lights or simply by having fewer keys. In these situations there always is a “What if?” factor. What if an elderly person doen't has on their glasses to locate the key? What if a women carrying bags drops her keys in her bushes trying to get into the house? What if the electricity is out? All of these factors playa role in safety. By having Love Glows, it provides another from of safer for all people and makes life a bit easier.

### SUMMARY OF THE INVENTION

A key of personal choice made by the customer will feature a plastic add on piece which illuminates in the dark. This will provide easy access for locating keys' and trying to prevent crimes from occurring.

### BRIEF DESCRIPTION OF THE DRAWINGS

FIG. 1: Shows one embodiment of the key present invention with batteries in place under the plastic compartment.

FIG. 2: Shows on embodiment of the key present invention side view where batteries are located.

FIG. 3: Shows front view of key with liquid substance in place under compartment and key holder.

FIG. 4: Shows the side view of the key with liquid substance.

FIG. 5: Shows the front view of key with present invention with solar power and key holder.

FIG. 6: Shows the side view of the present invention with solar cell panel and battery in place.

### DETAILED DESCRIPTION OF THE INVENTION

The key is designed to be easily identified in less that optimal lighting. In these times of criminal activities, emergencies, illnesses, late night arrival; this illuminated key will allow for easy identification for opening of a designated secure lock (homes, businesses, cars, machinery, consumer padlocks) ect. The key is made of metal that is firm and sturdy. It also has a plastic center piece. The key comes in a variety of illuminating colors. The key will enable children, adults, seniors and disabled people to gain access to secure key locks quicker during times of less optimal lighting. The key can be any size as long as it's small enough for a person to transport. Preferably, the key is small enough to be carried on a key ring. The key will also be preferably, in the shape of normal keys. Practically this invention can be applied to all keys for easy identification during times of less optimal lighting.

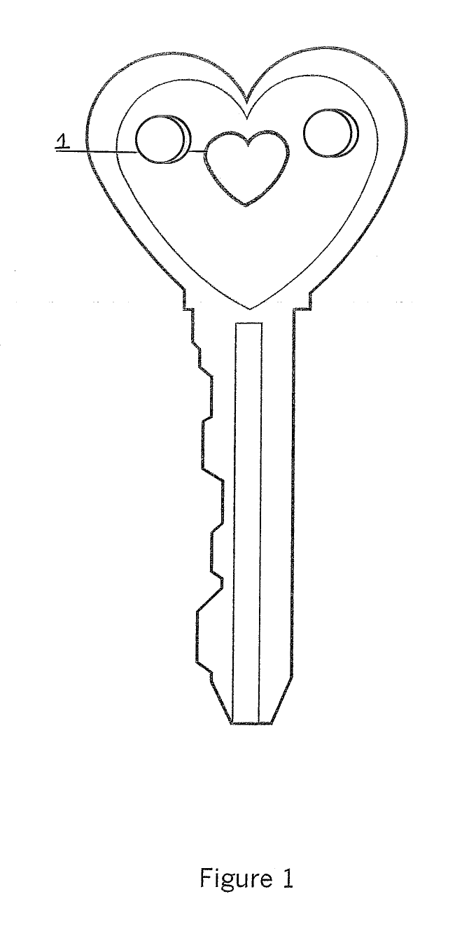

FIG. 1 Shows the key with a plastic hollow insert and batteries located on each side.

During less than optimal lighting the key will illuminate;

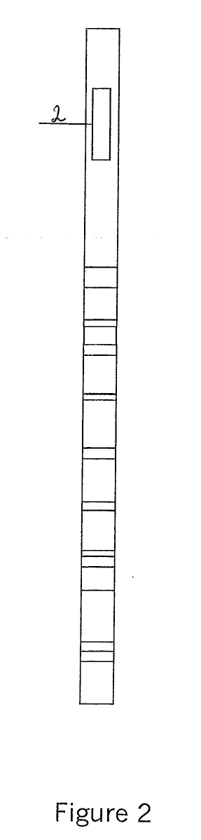

FIG. 2 Shows side view of the key with battery compartment located at the top;

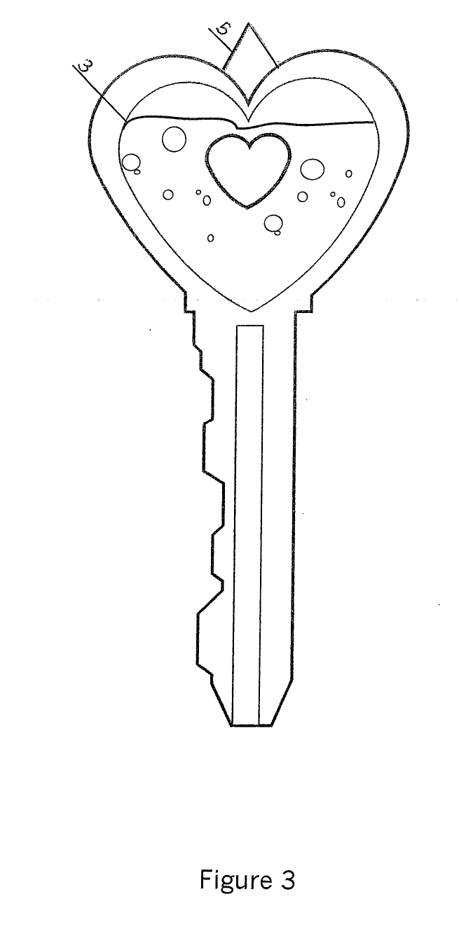

FIG. 3 Shows a liquid substance under plastic which will illuminate in the dark; and key holder.

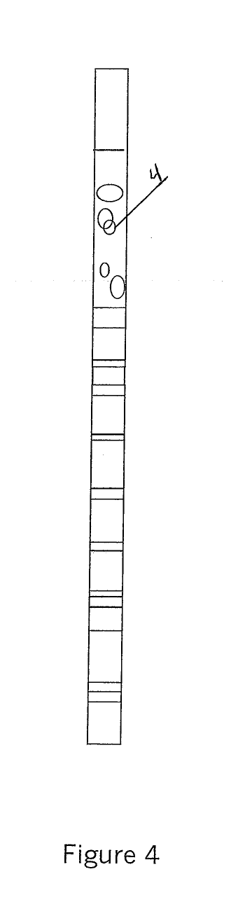

FIG. 4 Shows side views of key will liquid substance;

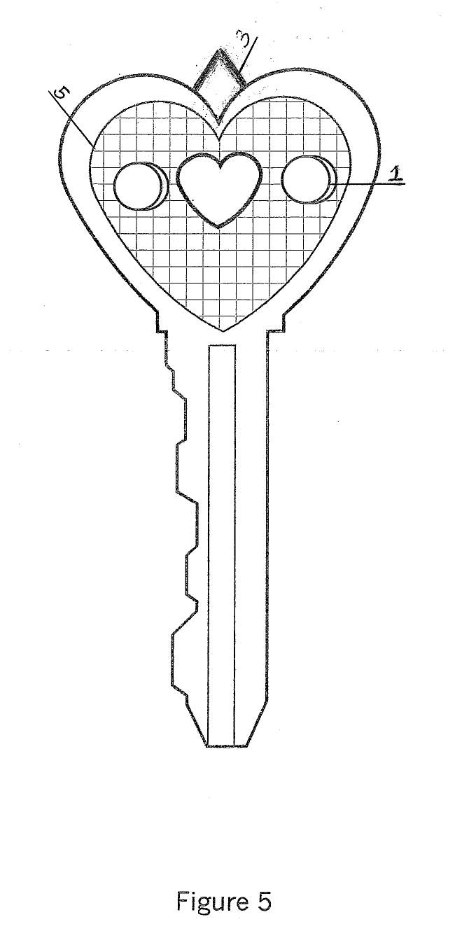

FIG. 5 Shows the solar panel and plastic which light up during times of less than optimal light and key holder.

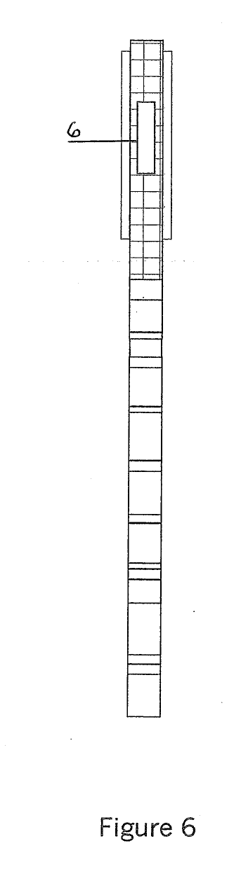

FIG. 6 Shows the key's side view where solar cell panel, plastic and battery is located.

1. A key comprising a sturdy material made of metal and plastic. The key is made of two sections, under the plastic the key will illuminate.

2. A key as in claim 1 between the metal and plastic will illuminate unlimited illuminating colors.

3. In the key component in claim 1 under plastic contains a liquid substance.

4. A key as in claim 1 has solar cell panel illuminating.

5. A key as in claim 1 has a heart shaped hollow hole in center of key.

6. A key comprising a sturdy material in claim 1 will contain led batteries under plastic compartment.

7. A key as in claim 1 the holder is also used for carrying key.
